(19) United States
(12) Patent Application Publication
(10) Pub. No.: US 2015/0317181 A1
(43) Pub. Date: Nov. 5, 2015

(54) OPERATING SYSTEM SWITCHING METHOD

(71) Applicant: Acer Incorporated, New Taipei City (TW)

(72) Inventors: Wei CHIANG, New Taipei City (TW); Rung-Lung LIN, New Taipei City (TW); Chi-Hsiu KAO, New Taipei City (TW); Yen-Wen CHEN, New Taipei City (TW)

(21) Appl. No.: 14/687,213

(22) Filed: Apr. 15, 2015

(30) Foreign Application Priority Data
Apr. 30, 2014 (TW) 103115484

(51) Int. Cl. G06F 9/46

(52) U.S. Cl. CPC G06F 9/461

(57) ABSTRACT

An operating system switching method for use in an electronic device is provided. The method includes the steps of: determining whether the first operating system receives an operating system switching command at time t1; storing first status data to a volatile memory and a non-volatile memory when a first operating system enters a non-operating state from an operating state based on the operating system switching command; writing second status data stored in the non-volatile memory to the volatile memory; and controlling the second operating system to enter the operating state from the non-operating state and recover to the operating status at time t2 based on the second status data stored in the volatile memory, wherein time t2 is earlier than time t1.

### CROSS REFERENCE TO RELATED APPLICATIONS

This Application claims priority of Taiwan Patent Application No. 103115484, filed on Apr. 30, 2014, the entirety of which is incorporated by reference herein.

### BACKGROUND OF THE INVENTION

1. Field of the Invention

The present invention relates to an operating system switching method, and, in particular, to an operating system switching method using the S3 state defined in the “Advanced Configuration and Power Interface (ACPI)” standard.

2. Description of the Related Art

Conventionally, the Windows operating system developed by Microsoft has been widely used in many electronic devices. However, electronic devices equipped with the Android operating system, which is based on the Linux operating system, have become more and more popular. Since the Windows and Android operating systems performs differently when performing tasks, these two operating systems can be integrated into the same electronic device, and thus the advantages of these two operating systems can be fully utilized.

Generally, only one operating system is operating and the other operating system enters a sleep state at the same time in an architecture with two operating systems, thereby preventing unnecessary conflict between two operating systems that share the same system resources. When switching between the operating systems, the electronic device usually stores the current settings or statuses of the current operating system, and thus the same operating status can be recovered when the operating system is activated again.

However, it should be noted that long switching time or using the main memory to store settings of the operating system may occur in a conventional electronic device. Accordingly, an improvement in the switching between different operating systems in the conventional electronic devices is desired.

### BRIEF SUMMARY OF THE INVENTION

A detailed description is given in the following embodiments with reference to the accompanying drawings.

In an exemplary embodiment, an operating system switching method for use in an electronic device is provided. The electronic device includes a first operating system and a second operating system. The method includes the steps of: determining whether the first operating system receives an operating system switching command at time t1, wherein the operating system switching command is for controlling the electronic device to switch between the first operating system and the second operating system; storing first status data to a volatile memory and a non-volatile memory when the first operating system enters a non-operating state from an operating state based on the operating system switching command, wherein the first status data records an operating status of the first operating systems at time t1; writing second status data stored in the non-volatile memory to the volatile memory, wherein the second status data records an operating status of the second operating system at time t2; and controlling the second operating system to enter the operating state from the non-operating state and recover to the operating status at time t2 based on the second status data stored in the volatile memory, wherein time t2 is earlier than time t1, and the operating state is state S0 as defined in the Advanced Configuration and Power Interface (ACPI) standard, and the non-operating state is state S3 as defined in the ACPI standard.

In another exemplary, an electronic device is provided. The electronic device includes a first operating system and a second operating system. The electronic device includes: a volatile memory; a non-volatile memory; a central processing unit (CPU); and an embedded controller; wherein the CPU stores first status data to a volatile memory and a non-volatile memory when the first operating system is operated in an operating state and the CPU receives an operating system switching command at time t1, wherein the embedded controller writes the first status data stored in the volatile memory to the non-volatile memory, and the first status data records an operating status of the first operating systems at time t1; wherein the embedded controller further writes second status data stored in the non-volatile memory to the volatile memory, wherein the second status data records an operating status of the second operating system at time t2; wherein the CPU controls the second operating system to enter the operating state from the non-operating state and recover to the operating status at time t2 based on the second status data stored in the volatile memory, wherein time t2 is earlier than time t1, and the operating state is state S0 as defined in the Advanced Configuration and Power Interface (ACPI) standard, and the non-operating state is state S3 as defined in the ACPI standard.

### BRIEF DESCRIPTION OF THE DRAWINGS

The present invention can be more fully understood by reading the subsequent detailed description and examples with references made to the accompanying drawings, wherein:

FIG. 1 is a diagram illustrating an electronic device in accordance with an embodiment of the invention;

FIG. 2 is a diagram illustrating the switching of operating systems in accordance with an embodiment of the invention;

FIG. 3 is a flow chart of an operating system switching method in accordance with an embodiment of the invention; and

FIG. 4 is a flow chart of an operating system switching method in accordance with another embodiment of the invention

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

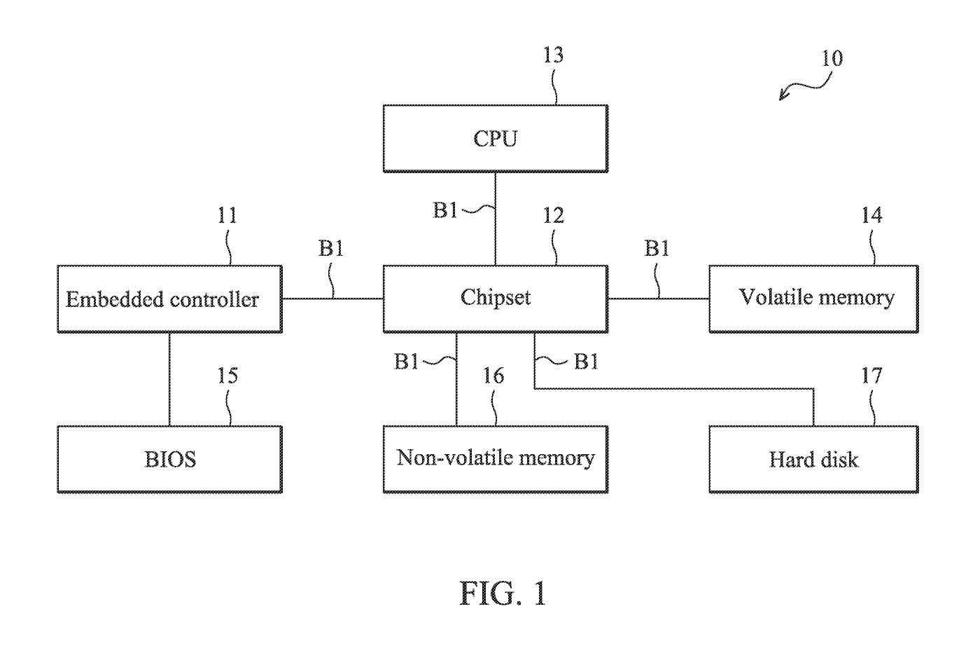

FIG. 1 is a diagram illustrating an electronic device in accordance with an embodiment of the invention. As shown in FIG. 1, the electronic device 10 may be a laptop, a tablet PC, a handheld electronic device, or a smartphone, but the invention is not limited thereto. In an embodiment, the electronic device 10 may comprise an embedded controller (EC) 11, a chip set 12, a central processing unit 13, a volatile memory 14, a basic input-output system (BIOS) 15, a non-volatile memory 16, and a hard disk, but the components of the electronic device 10 are not limited to the aforementioned components.

The volatile memory 14 may be a dynamic random access memory (DRAM) or a static random access memory (SRAM), but the volatile memory 14 is not limited thereto. In an embodiment, the volatile memory 14 is regarded as a main memory, which is used for loading various programs and data being executed and used by the CPU 13. In the embodiment, the volatile memory 14 is configured to store data, and the stored data cannot be kept when the power of the volatile memory 14 is turned off. In an embodiment, the CPU 13 may access data stored in the volatile memory 14 indirectly through the chipset 12. In another embodiment, the CPU 13 may directly access the data stored in the volatile memory 14. In the following sections, the accessing of the volatile memory by the CPU 13 may indicate direct or indirect accessing of the data stored in the volatile memory 14.

The BIOS 15 stores program codes for setting up parameters of the operating mode and hardware. For example, the BIOS 15 may include program codes as a kernel for controlling the booting-up procedure or the switching of the operating systems. In an embodiment, when the electronic device 10 boots up or the current operating system is switched, the program codes stored in the BIOS 15 are the very first program executed by the CPU 13.

The EC 11 is electrically connected between the chipset 12 and the BIOS 15. In the embodiment, the EC 11 may execute a specific command based on the program codes of the BIOS 15. For example, when the electronic device 10 is powered up or is rebooted, the EC 11 may execute the associated booting processes based on the program codes of the BIOS 15. Specifically, when the electronic device 10 is booted up or the current operating system is switched, the EC 11 may initialize the main memory based on the program code of the BIOS 15, and load associated program codes to the main memory from the BIOS 15. Afterwards, the CPU 13 may execute the booting procedure or corresponding processes for loading and executing the operating system based on the program codes of the BIOS 15. In an embodiment, the BIOS 15 can be integrated into the EC 11, but the invention is not limited thereto.

The chipset 12 is electrically coupled to the CPU 13 and the EC 11, and the chipset 12 intercommunicates between the CPU 13, the EC 11 and other hardware devices. In an embodiment, the chipset 12 includes a memory controller (not shown in FIG. 1) for controlling accessing of the volatile memory 14 or the non-volatile memory 16. For example, the chipset 12 accesses the volatile memory 14, non-volatile memory 16, and/or the hard disk 17 by receiving a command from the CPU 13. In an embodiment, the chipset 12 includes a southbridge chip and a northbridge chip, but the invention is not limited thereto. In another embodiment, the EC 11 can be integrated into the chipset 12, but the invention is not limited thereto.

The non-volatile memory 16 may be a hard disk, a solid-state disk (SSD), a USB portable memory device, a compact disk, or a combination thereof, but the invention is not limited thereto. The non-volatile memory 16 stores various programs and data that can be being accessed by the CPU 13. In the embodiment, the CPU 13 may access the data stored in the non-volatile memory 16 through the chipset 12, but the invention is not limited thereto. In an embodiment, the non-volatile memory 16 is regarded as an auxiliary memory.

The CPU 13 controls each component in the electronic device 10 via the chipset 12. In the embodiment, when the first operating system is to be executed by the electronic device 10, the first operating system is loaded into the main memory, and the electronic device 10 may execute associated operations based on the first operating system. Similarly, when the second operating system is to be executed by the electronic device 10, the second operating system is loaded into the main memory, and the electronic device 10 may execute associated operations based on the second operating system. For example, when the electronic device 10 is booted up or the current operating system is switched, the EC 11 and the chipset 12 may load the operating system stored in the non-volatile memory 16 or the hard disk 17 to the volatile memory 14 based on the program codes of the BIOS 15, thereby completing the booting sequence or the switching of the operating systems, but the invention is not limited thereto.

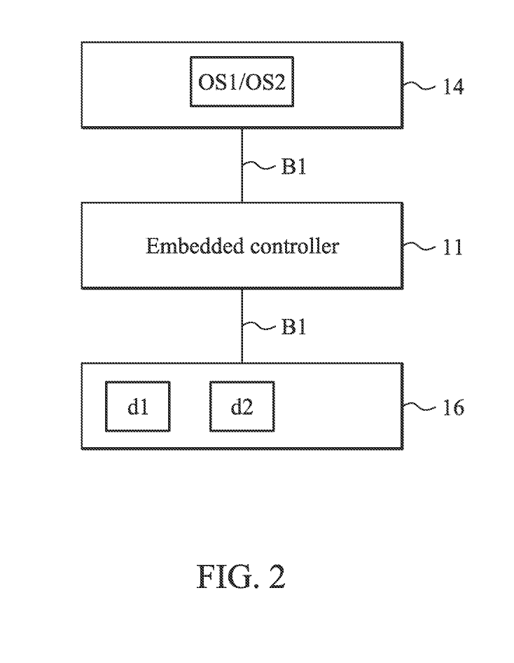

FIG. 2 is a diagram illustrating switching of operating systems in accordance with an embodiment of the invention. Referring to FIG. 2, in an embodiment, when the first operating system OS1 is executed by the electronic device 10, the first operating system OS1 is loaded into the volatile memory 14. The CPU 13 may execute corresponding operations based on the first operating system OS1 stored in the volatile memory 14. Similarly, when the second operating system OS2 is executed by the electronic device 10, the second operating system OS2 is loaded into the volatile memory 14. In an embodiment, the steps for loading the operating system into the volatile memory 14 include the EC 11 loading/writing the operating system into the volatile memory 14 from the non-volatile memory 16 via the chipset 12 based on program codes of the BIOS 15. In the embodiment, a first status data d1 or a second status data d2 are stored in the non-volatile memory 16. The first status data records the operating status of the first operating system OS1 at time t1. Similarly, the second status data d2 records the operation status of the second operating system d2 at time t2.

In the embodiment, the operating status of the first operating system OS1 at time t1 can be recovered based on the first status data d1. Specifically, when the first operating system OS1 is executed by the CPU 13, the CPU 13 may recover the operating status of the first operating system OS1 to the operating status at time t1 based on the first status data d1. Similarly, the operating status of the second operating system OS2 can be recovered to the operating status at time t2 based on the second status data d2. In an embodiment, the EC 11 may load/write the first status data d1 or the second status data d2 stored in the non-volatile memory 16 to the volatile memory 14 via the chipset 12.

The ACPI standard is a power-management specification for personal computers, which allows the first operating system or the second operating system to manage the power status of each component directly. For example, the first operating system OS1 may stop the computation of the CPU 13 and turn off the CPU 13 via the ACPI interface. The power status S0, S1, S2, S3, S4 and S5 defined in the ACPI standard are described as follows:

S0 (normal working state): the electronic device 10 operates normally. In the embodiment, state S0 can be regarded as an execution status.

S1 (power on suspend, POS): the CPU 13 of the electronic device 10 stops computation in state S1, but other hardware components are still working normally.

S2: the power of the CPU 13 is turned off by the electronic device 10, but other hardware components are still working normally.

S3: (sleeping state or standby state): the volatile memory 14 and the EC 11 are two of the several components supplied with power in state S3. For example, the first status data dl of the first operating system is stored in the volatile memory 14 when the first operating system enters state S3, wherein the first status data d1 records the previously-executed applications and documents in the first operating system. Similarly, the second status data d2 is stored in the volatile memory 14 when the second operating system enters state S3, wherein the second status data d2 records the previously-executed applications and documents in the second operating system. When the first operating system goes back to state S0 from state S3, the first operating system is recovered to state S0 based on the first status data d1 stored in the volatile memory 14. Similarly, when the second operating system goes back to state S0 from state S3, the second operating system is recovered to state S0 based on the second status data stored in the volatile memory 14. In other words, the electronic device 10 can be recovered to the previous operating status before entering state S3 based on the first status data d1 or the second status data s2. It should be noted that the first operating system or the second operating system may only read data from the volatile memory 14 when the first operating system or the second operating system is awakened to state S0 from state S3. In the embodiment, state S3 is regarded as a non-operating state.

S4: (sleeping state): both states S3 and S4 are sleep states, but the hardware configurations of hardware components are not completely the same in states S3 and S4. In state S4, most components of the electronic device 10 are not supplied with power. In addition, all data in the volatile memory 14 (e.g. the first status data d1 or the second status data d2) are stored in the non-volatile memory 16, thereby recording the current operating status of the first and second operating systems including previously-executed applications and documents. In the embodiment, the non-volatile memory 16 may be a SSD, a USB portable disk, or a combination thereof, but the invention is not limited thereto. When the electronic device 10 is awakened from state S4, the electronic device 10 can be recovered to state S0 before entering state S4, which is similar to the behavior of state S3. It should be noted that the first/second operating systems may read data from the non-volatile memory 16 when the first/second operating systems are awakened to state S0 from state S4.

S5 (soft off state): the hardware configuration of state S5 is similar to that of state S4 except that the operating system does not store any data in state S5. When the electronic device 10 is in state S5, only a few components are supplied with a little power by the electronic device 10, and other components are turned off.

In view of the above, the difference between states S3 and S4 is that the status data of the current operating system is stored in the non-volatile memory 16 in state S4 and the status data can be maintained without supplying additional power to the non-volatile memory 16. Conversely, the status data of the current operating system is stored in the volatile memory 14 in state S3, and the data in the volatile memory 14 may disappear when the power of the volatile memory 14 is turned off.

In addition, the first status data d1 or the second status data d2 are stored in the volatile memory 14 in state S3. When the electronic device 10 is awakened from state S3, the CPU 13 may read the status data from the volatile memory 14 directly, and thus the recovery speed is faster. Conversely, the first status data d1 or the second status data d2 are stored in the non-volatile memory 16 in state S4, and thus the CPU 13 has to read the first status data d1 or the second status data d2 from the non-volatile memory 16 and load the retrieved first/second status data to the volatile memory 14. Afterwards, the CPU 13 may read the first status data d1 or the second status data s2 from the volatile memory 14. Accordingly, the recovery speed in state S4 is slower than that in state S3, and thus the recovery time of the operating system from state S4 to S0 is longer than that from state S3 to S0.

In some embodiments, different power configurations state S0˜S5 can be used in the first operating system OS1 and the second operating system OS2 of the electronic device 10. For example, the S3 state power configuration is used by the electronic device 10 to switch to the second operating system OS2 from the first operating system OS1. First, the CPU 13 may store the first status data d1 of the first operating system OS1 to the volatile memory 14. For example, the CPU 13 may store the first status data d1 to the volatile memory 14 via the chipset 12. Afterwards, the CPU 13 may read the previously-stored second status data d2 of the second operating system OS2 from the volatile memory 14, and the second operating system OS2 can be recovered to state S0 from state S3.

Specifically, the CPU 13 has to load the second operating system OS2 to the volatile memory 14, so that the CPU 13 may execute the second operating system OS2. Subsequently, the second operating system OS2 can be recovered to the previous operating status based on the second status data d2. When the second operating system OS2 enters state S0, the first status data d1 of the first operating system OS1 are still maintained in the volatile memory 14, and thus the available memory space in the volatile memory 14 is reduced.

In another embodiment, the S4 state power configuration is used in the electronic device 10 to switch to the first operating system OS1 to the second operating system OS2. First, the CPU 13 stores the first status data d1 of the first operating system OS1 to the non-volatile memory 16, and then stores the second status data d2 previously-stored in the non-volatile memory 16 to the volatile memory 14. Afterwards, the CPU 13 may read the second status data d2 from the volatile memory 14, so that the second operating system OS2 is recovered to state S0 from state S4. When the second operating system OS2 enters state S0, the first status data d1 of the first operating system OS1 is maintained in the non-volatile memory 16, and thus the first status data d1 does not occupy the memory space of the volatile memory 14 (i.e. main memory). However, the electronic device 10 has to read the second status data d2 from the non-volatile memory 16, and load the second status data d2 to the volatile memory 14, thereby the duration for switching operating systems is increased.

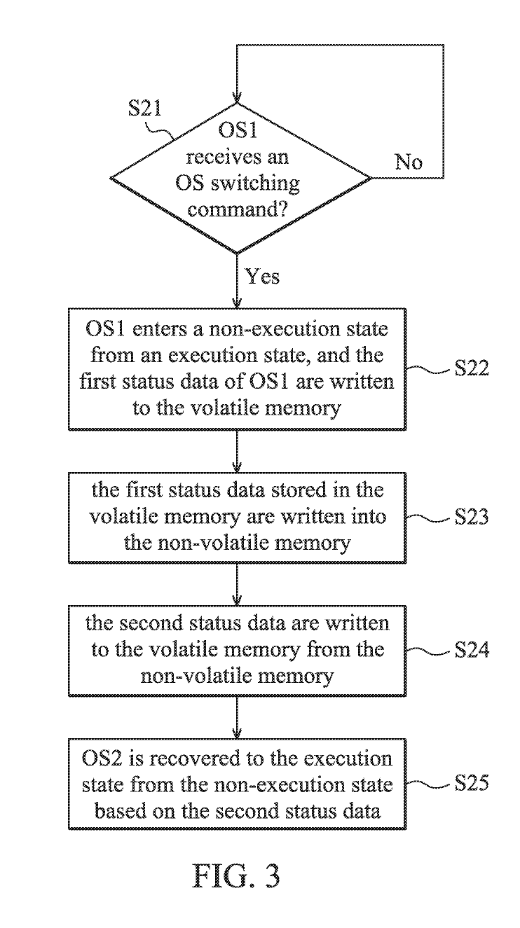

FIG. 3 is a flow chart of an operating system switching method in accordance with an embodiment of the invention. As shown in FIG. 3, in step S21, it is determined whether the first operating system OS1 has received an operating system switching command. If so, step S22 is performed. Otherwise, step S21 is performed. The operating system switching command can be triggered by a hardware button or a software button displayed on the display of the electronic device 10, but the invention is not limited thereto. For example, the user may press on a hardware button of the electronic device 10 to switch the current operating system from the first operating system OS1 to the second operating system OS2.

In step S22, the first operating system OS1 enters a non-operating state from an operating state and the first status data d1 of the first operating system OS1 are written into the volatile memory. For example, the first operating system OS1 enters the non-operating state from the operating state at time t1, and the CPU 13 writes the first status data d1 of the first operating system OS1 to the volatile memory 14 via the chipset 12 at time t1.

In step S23, the first status data d1 stored in the volatile memory are written into the non-volatile memory 16, and then step S24 is performed. In an embodiment, the EC 11 may write the first status data d1 stored in the volatile memory 14 to the non-volatile memory 16 based on the program codes of the BIOS 15. In an embodiment, when the first operating system OS1 has received an operating system switching command, the EC 11 may copy the first status data d1 to the non-volatile memory 16 based on the program codes of the BIOS 15 and the operating system switching command. In another embodiment, when the first operating system OS1 has received the operating system switching command, the EC 11 may store the first status data d1 to the volatile memory 14 and copy the first status data d1 to the non-volatile memory 16.

It should be noted that the first operating system OS1 (or the CPU 13) merely stores the first status data d1 to the volatile memory 14, and thus the first operating system OS1 does not know that the first status data d1 has been stored into the non-volatile memory 16. In other words, the first operating system OS1 may only switch between the state S0 and state S3. In an embodiment, when the first status data d1 is loaded to the non-volatile memory 16 from the volatile memory 14, the EC 11 may clean the first status data d1 stored in the volatile memory 14 based on the program codes of the BIOS 15, or clean the first status data d1 stored in the volatile memory 14 via the chipset 12, but the invention is not limited thereto.

In step S24, the second status data d2 are written to the volatile memory 14 from the non-volatile memory 16, and then step S25 is performed. For example, the EC 11 may store/write the second status data d2 stored in the non-volatile memory 16 to the volatile memory 14. In an embodiment, based on the program codes of the BIOS 15, the EC 11 may write the first status data d1 to the non-volatile memory 16, and then load the second status data d2 from the non-volatile memory 16 to the volatile memory 14, but the invention is not limited thereto. In the embodiment, the second status data d2 is stored into the non-volatile memory 16 at time t2, wherein time t2 is earlier than time t1.

In step S25, the second operating system OS2 is recovered to the operating state from the non-operating state based on the second status data d2. For example, the CPU 13 may read the second status data d2 stored in the volatile memory 14, and recover the second operating system OS2 to state S0 from state S3. In other words, the second operating system OS2 may only switch between state S0 and state S3. In an embodiment, when the second operating system OS2 is recovered to state S0 from state S3, the CPU 13 may clean the second status data d2 stored in the volatile memory 14 and/or non-volatile memory 16, but the invention is not limited thereto.

It should be noted that the switching from the first operating system OS1 to the second operating system OS2 is described in the embodiment. A similar method can be used in the switching from the second operating system OS2 to the first operating system OS1, and the details will be omitted here. Furthermore, in some embodiments, a similar method can be used in an electronic device having three or more operating systems.

In an embodiment, the non-volatile memory 16 is a solid-state disk for storing the first status data d1 and the second status data d2. In another embodiment, the non-volatile memory 16 includes an SSD and a USB portable disk for storing the first status data d1 and the second status data d2, respectively. For example, the first operating system OS1 may be a Windows operating system, and the second operating system OS2 may be an Android operating system. In addition, the first status data d1 is stored in the SSD, and the second status data d2 is stored in the USB portable disk.

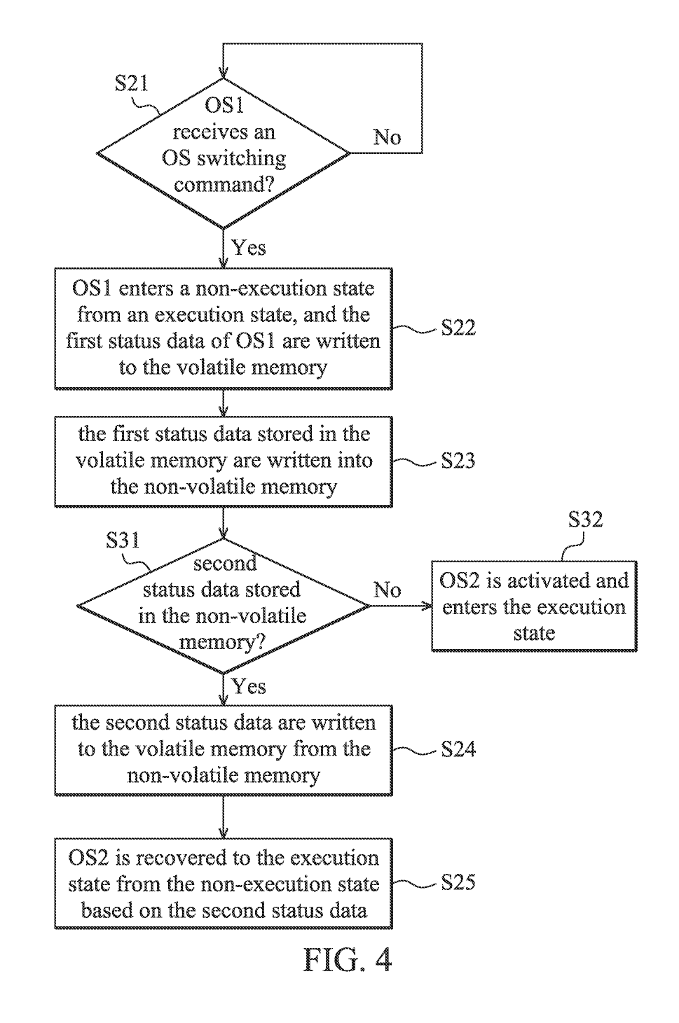

FIG. 4 is a flow chart of an operating system switching method in accordance with another embodiment of the invention. Referring to FIG. 4, the steps in FIG. 4 are similar to those in FIG. 3. The differences between FIG. 4 and FIG. 3 are that the steps of FIG. 4 further include steps S31 and S32. Details of steps S21˜S25 in FIG. 4 can be referred to in the description of steps S21˜S25 in FIG. 3.

In step S31, it is determined whether the second status data d2 is stored in the non-volatile memory 16. When the second status data d2 are stored in the non-volatile memory 16, step S24 is performed. Otherwise, step S31 is performed. For example, the CPU may read data of the non-volatile memory 16 via the chipset 12, and determine whether the second status data d2 are stored in the non-volatile memory 16. In an embodiment, the CPU 13 may read a specific segment of the non-volatile memory 16 via the chipset 12, and determine whether the second status data d2 are stored in the non-volatile memory 16. In step S32, the second operating system OS2 is activated and enters the operating state. In the embodiment, since the second status data d2 are not stored in the non-volatile memory 16, the CPU 13 may re-activate the second operating system OS2 to enter the operating state. For example, the second operating system OS2 can be activated from state S5, but the invention is not limited thereto.

In view of the above, the operating system of the electronic device 10 may only switch between state S0 and state S3 upon the operating systems being switched and there being status data for the operating system. Thus, the operating system may only access the status data stored in the volatile memory 14. Accordingly, the operating system can be switched rapidly in the electronic device 10. In addition, the electronic device 10 further writes the status data stored in the volatile memory to the non-volatile memory upon switching of the operating systems, so that the volatile memory is not required to maintain the status data and the storage space of the volatile memory will not be occupied. In other words, the issues for switching operating systems in a conventional electronic device can be resolved by the electronic device 10 of the invention.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An operating system switching method for use in an electronic device having a first operating system and a second operating system, the method comprising:
determining whether the first operating system receives an operating system switching command at time t1, wherein the operating system switching command is for controlling the electronic device to switch between the first operating system and the second operating system;
storing first status data to a volatile memory and a non-volatile memory when the first operating system enters a non-operating state from an operating state based on the operating system switching command, wherein the first status data records an operating status of the first operating systems at time t1;
writing second status data stored in the non-volatile memory to the volatile memory, wherein the second status data records an operating status of the second operating system at time t2; and
controlling the second operating system to enter the operating state from the non-operating state and recover to the operating status at time t2 based on the second status data stored in the volatile memory,
wherein time t2 is earlier than time t1, and the operating state is state S0 as defined in the Advanced Configuration and Power Interface (ACPI) standard, and the non-operating state is state S3 as defined in the ACPI standard.

2. The operating system switching method as claimed in claim 1, wherein when the first operating system or the second operating system is operated in the operating state, the first status data and the second status data are not stored in the non-volatile memory.

3. The operating system switching method as claimed in claim 1, wherein the step of writing the first status data to the volatile memory and the non-volatile memory comprises:
storing the first status data to the volatile memory, and writing the first status data to the non-volatile memory via an embedded controller of the electronic device.

4. The operating system switching method as claimed in claim 3, wherein the step of storing the first status data into the volatile memory and the non-volatile memory further comprises:
controlling the embedded controller to clean the first status data stored in the volatile memory when the first status data is written into the non-volatile memory.

5. The operating system switching method as claimed in claim 1, wherein the non-volatile memory is a solid-state disk.

6. The operating system switching method as claimed in claim 1, wherein the non-volatile memory comprises a solid-state disk and a USB portable disk, and the first status data and the second status data are stored in the solid-state disk and the USB portable disk, respectively.

7. The operating system switching method as claimed in claim 6, wherein the first operating system is the Windows™ operating system, and the second operating system is the Android™ operating system.

8. An electronic device, equipped with a first operating system and a second operating system, comprising:
a volatile memory;
a non-volatile memory;
a central processing unit (CPU); and
an embedded controller;
wherein the CPU stores first status data to a volatile memory and a non-volatile memory when the first operating system is operated in an operating state and the CPU receives an operating system switching command at time t1, wherein the embedded controller writes the first status data stored in the volatile memory to the non-volatile memory, and the first status data records an operating status of the first operating systems at time t1;
wherein the embedded controller further writes second status data stored in the non-volatile memory to the volatile memory, wherein the second status data records an operating status of the second operating system at time t2;
wherein the CPU controls the second operating system to enter the operating state from the non-operating state and recover to the operating status at time t2 based on the second status data stored in the volatile memory,
wherein time t2 is earlier than time t1, and the operating state is state S0 as defined in the Advanced Configuration and Power Interface (ACPI) standard, and the non-operating state is state S3 as defined in the ACPI standard.

9. The electronic device as claimed in claim 8, wherein when the first operating system or the second operating system is operated in the operating state, the first status data and the second status data are not stored in the non-volatile memory.

10. The electronic device as claimed in claim 8, wherein the embedded controller further clean the first status data stored in the volatile memory when the first status data is written to the non-volatile memory.

11. The electronic device as claimed in claim 8, wherein the non-volatile memory is a solid-state disk.

12. The electronic device as claimed in claim 8, wherein the non-volatile memory comprises a solid-state disk and a USB portable disk, and the first status data and the second status data are stored in the solid-state disk and the USB portable disk, respectively.

13. The electronic device as claimed in claim 12, wherein the first operating system is the Windows™ operating system, and the second operating system is the Android™ operating system.
